(19) United States
(12) Patent Application Publication
(10) Pub. No.: US 2007/0002364 A1
(43) Pub. Date: Jan. 4, 2007

(54) Imaging device

(76) Inventors: Duane A. Koehler, Vancouver, WA (US); Volker Smektala, Camas, WA (US); Lee W. Jackson, Vancouver, WA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/169,561

(22) Filed: Jun. 29, 2005

(51) Int. Cl. G06F 3/12

(52) U.S. Cl. 358/1.15; 358/520; 358/448

(57) ABSTRACT

Embodiments of an imaging device are disclosed.

### BACKGROUND

Image-capturing devices, such as digital cameras, are often connected directly to an imaging device, such as a printer, for outputting hard-copy images corresponding to image data stored on the image-capturing devices. This typically involves including a host controller, e.g., a USB (Universal Serial Bus) host controller, in the imaging device so that the image-capturing devices can communicate with the imaging device. A host controller can add material cost, firmware complexity, and testing cost to the imaging device. Moreover, additional memory is often included that can further increase the cost of the imaging device.

### DESCRIPTION OF THE DRAWINGS

FIG. 1 is a block diagram illustrating an embodiment of an imaging device, according to an embodiment of the present disclosure.

FIG. 2 is a flowchart of an embodiment of a method, according to another embodiment of the present disclosure.

### DETAILED DESCRIPTION

In the following detailed description of the present embodiments, reference is made to the accompanying drawings that form a part hereof, and in which is shown by way of illustration specific embodiments that may be practiced. These embodiments are described in sufficient detail to enable those skilled in the art to practice disclosed subject matter, and it is to be understood that other embodiments may be utilized and that process, electrical or mechanical changes may be made without departing from the scope of the claimed subject matter. The following detailed description is, therefore, not to be taken in a limiting sense, and the scope of the claimed subject matter is defined only by the appended claims and equivalents thereof.

Embodiments of the disclosure enable users to connect an image-capturing device, such as a digital camera, to an imaging device, such as a printer, and to print images from the imaging device. The imaging device is connected to a host, such as a personal computer. Connecting the imaging device to the host enables processing-power intensive and memory-intensive operations to be performed by unused memory and processing power of the host. This reduces the memory that would be included in the imaging device and reduces the complexity of a host controller in the imaging device, or in some embodiments may allow for an imaging device that would not include a host controller, thereby reducing the cost of the imaging device without a substantial increase in the time for the image processing operations associated with printing the image. For some embodiments, the memory requirements of the imaging device are reduced so that the memory can be embedded in an ASIC.

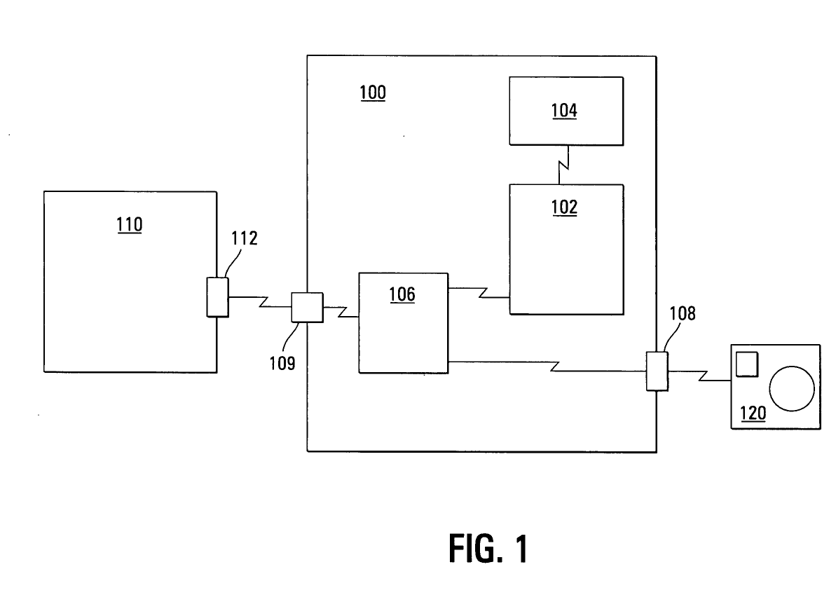

FIG. 1 is a block diagram illustrating an imaging device 100, such as a printer, a multi-function peripheral (MFP), or the like, connected to a host device 110, such as a personal computer, and an image-capturing device 120, such as a digital camera, a scanner, and/or a card reader, according to an embodiment. For one embodiment, imaging device 100 includes a controller 102, such as a formatter or a print engine controller, connected to a print engine 104.

For one embodiment, imaging device 100, receives data from host device 110. This data would include pre-rendered image data and commands to control the imaging device hardware. In some embodiments, the entire compute-intensive image rendering processes could be done in the host. Controller 102 interprets the image data and converts it into signals used to control print engine motors and place ink drops on the media. The printable image is provided to print engine 104 to produce a hard-copy image on a media sheet. For another embodiment, controller 102 may be an application specific integrated circuit (ASIC), a field programmable gate array (FPGA), or the like. For another embodiment, the memory of imaging device 100 is embedded in the ASIC.

For one embodiment, controller 102 is connected to a hub integrated circuit 106, such as a USB (Universal Serial Bus) hub integrated circuit. One suitable hub integrated circuit is a Cypress CY7C65640 from Cypress Semiconductor Corp. (San Jose, Calif., USA). For another embodiment, hub integrated circuit 106 may be integrated within controller 102. The hub integrated circuit 106 is also connected to image-capturing device 120 via a port 108, such as a USB port, of imaging device 100 and to host device 110 via a port 109, such as a USB port, of imaging device 100, and a port 112, such as a USB port, of host device 110.

For one embodiment, hub integrated circuit 106 receives image data from image-capturing device 120 and distributes it to the host device 110. The host receives the image data and performs processing steps that are involved in printing the image. These processing steps may include but are not limited to jpeg decompression, scaling, rotation, thumbnail and n-up layout, color-matching, half-toning, swath-cutting, red-eye reduction, image enhancement, and error correction. Some embodiments may use the host device for a subset of these processes and complete the remaining processes in the imaging device without substantial use of the host device. Controller 102 receives the processed image data from host device 110, for one embodiment, converts the image data into a printable image, and generates the signals used to control print engine motors and place ink drops on the media. The printable image is provided to print engine 104 to produce a hard-copy image on a media sheet.

In one embodiment, the image-capturing device 120 would be a memory device, such as a flash memory “thumb drive” that is connected to a host port, such as a USB host port, of the imaging device.

In another embodiment, the image capturing device 120 could be an external card-reader device, which would enable camera memory cards to be read and the image data transferred through the hub circuit 106 in the same manner as if the data were coming directly from a image capture device.

In another embodiment, the image-capturing device 120 could be a wireless device, including but not limited to those which use Bluetooth or WiFi protocols. This would enable the imaging device to receive image data from a wireless device, including but not limited to cell phones, PDAs, or external wireless host devices.

When image-capturing device 120 is connected to imaging device 100, host device 110 performs a device enumeration (or an identification/initialization process) to verify that the image-capturing device connected through the hub circuit 106 is a valid USB device, and to identify its Vendor ID, and its Product ID. During enumeration, the host will attempt to load initializing routines (drivers) that enable image-capturing device 120 to interact with host device 110 and to interact with imaging device 100 via host device 110. For one embodiment, host device 110 activates a driver for controlling imaging device 100, e.g., a print driver, installed on host device 110 in response to a print request from image-capturing device 120 that is initiated by inputs to image-capturing device 120 by the user thereof. The print driver in turn provides the data processing for the imaging device 100 to print images corresponding to the image data from image-capturing device 120. This processing may include, but is not limited to, jpeg decompression, scaling, rotation, thumbnail and n-up layout, color-matching, half-toning, swath-cutting, red-eye reduction, image enhancement, and error correction.

For one embodiment, host device 110 includes a host communications protocol, such as a USB host communications protocol (e.g., PictBridge), that enables the enumeration and enables the user of image-capturing device 120 to communicate with host hardware, such as USB host hardware, within host device 110 via a user interface of image-capturing device 120 when host device 110 is on. For example, the user will be able to identify pictures to be printed and select options (size, number copies, cropping, etc.) from the user interface of image-capturing device 120. For another embodiment, host device 110 performs color matching, image processing, image rotation, image enhancement (red-eye reduction, luminance and chroma enhancement, etc.), etc. in response to user inputs to image-capturing device 120. This interaction by the user is managed by the driver software in the host device 110, in concert with firmware in the imaging device 100. These processes may be allocated to either the driver software in the host device 110 or the firmware in the imaging device 100, depending upon product useablity goals, memory usage, and processing operations to be performed.

Image-capturing device 120 sends print jobs to host device 110 in response to user inputs to image-capturing device 120. Host device 110 downloads image data from image-capturing device 120 and sends them to imaging device 100 for printing. For another embodiment, host device 110 rasterizes the image data before sending it to imaging device 100 for printing. For another embodiment, host device 110 decompresses the image data after downloading it and before rasterizing it.

For some embodiments, a display of image-capturing device 120 is echoed to a monitor connected to host device 110, such as a computer monitor. For another embodiment, host device 110 supports a USB “high speed” (e.g., 480 Mbits/sec) bandwidth. This enables imaging device 100 to support a high-speed bandwidth for image-capturing devices that support USB high speed.

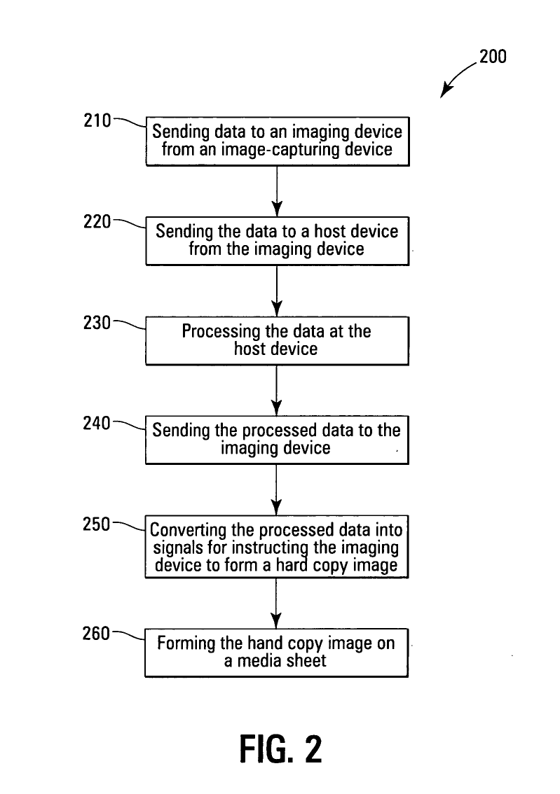

FIG. 2 is a flowchart of a method 200, according to another embodiment. At block 210, unprocessed image data is sent to hub integrated circuit 106 of imaging device 100 from image-capturing device 120 in response to user inputs to image-capturing device 120. Hub integrated circuit 106 sends the unprocessed image data to host device 110 at block 220. For some embodiments, additional signals are sent between image-capturing device 120 and host device 110 via hub integrated circuit 106 for performing the device enumeration described above. At block 230, host device 110 processes the data. Host device 110 then sends the processed data to controller 102 of imaging device 100 via hub integrated circuit 106 at block 240. At block 250, controller 102 converts the processed data into signals (or commands) for instructing print engine 104 to form a hard-copy image from the processed data. Print engine 104 forms the hard-copy image on a media sheet at block 260 in response to the signals.

### CONCLUSION

Although specific embodiments have been illustrated and described herein it is manifestly intended that the scope of the claimed subject matter be limited only by the following claims and equivalents thereof.

What is claimed is:

1. A method, comprising:
sending data from an image-capturing device through an imaging device to a host device; and
forming a hard-copy image with the imaging device using processed data received from the host device.

2. The method of claim 1, wherein sending data from an image-capturing device through an imaging device to a host device comprises sending the data through a hub integrated circuit of the imaging device.

3. The method of claim 1 further comprises converting the processed data into signals for instructing the imaging device to form the hard-copy image.

4. The method of claim 3 further comprises forming the hard-copy image on a media sheet using the imaging device.

5. The method of claim 1 further comprises echoing a display of the image-capturing device on a monitor of the host device.

6. The method of claim 1 further comprises identifying the image-capturing device at the host device before sending the data to the host device from the image-capturing device.

7. The method of claim 6 further comprises initializing the image-capturing device at the host device before sending the data to the host device from the image-capturing device.

8. A method, comprising:
identifying and initializing an image-capturing device at a host device;
sending data to the host device from the image-capturing device through an imaging device in response to user inputs to the image-capturing device;
processing the data at the host device;
sending the processed data to the imaging device from the host device; and
forming a hard-copy image corresponding to the processed data using the imaging device.

9. The method of claim 8 further comprises, before identifying and initializing the image-capturing device, communicatively coupling the image-capturing device to the host device by connecting the image-capturing device to the imaging device that is connected to the host device.

10. The method of claim 8, wherein sending data to the host device from the image-capturing device through the imaging device comprises sending the data through a hub integrated circuit within the imaging device.

11. The method of claim 8 further comprises converting the processed data into signals for instructing the imaging device to form the hard-copy image before forming the hard copy image.

12. The method of claim 8 further comprises rasterizing the data at the host device before sending the data to the imaging device.

13. The method of claim 8 further comprises activating a driver for controlling the imaging device in response to a user input to the image-capturing device.

14. A computer-usable medium containing computer-readable instructions for causing a host device to perform a method comprising:
sending data from an image-capturing device through an imaging device to a host device; and
forming a hard-copy image with the imaging device using processed data received from the host device.

15. The computer-usable medium of claim 14, wherein the method further comprises rasterizing the data before sending the data to the imaging device.

16. The computer-usable medium of claim 14, wherein the method further comprises performing at least one of color matching, image processing, image rotation, image enhancement in response to user inputs to the image-capturing device.

17. A system comprising:
a means for sending data from an image-capturing device through an imaging device to a host device; and
a means for forming an image using processed data received from the host device.

18. The system of claim 17 further comprises a means for identifying and initializing the image-capturing device at the host device before sending the data to the host device from the image-capturing device.

19. The system of claim 17 further comprises a means for activating a driver for controlling the imaging device in response to a user input to the image-capturing device before sending the data to the host device from the image-capturing device.

20. A system comprising:
a host device adapted to form processed data from data; and
an imaging device comprising a circuit for providing the data from an image-capturing device to the host device and receiving the processed data from the host device.

21. The system of claim 20, wherein the circuit is a hub integrated circuit.

22. The system of claim 20, wherein the host device is further adapted to activate a driver for controlling the imaging device in response to a user input to the image-capturing device.

23. The system of claim 20, wherein the image-capturing device is at least one of a digital camera, a scanner, a card reader, memory device, and a wireless device.

24. The system of claim 20, wherein the host device is further adapted to perform at least one of color matching, image processing, image rotation, image enhancement in response to user inputs to the image-capturing device.

25. The system of claim 20, wherein the host device is further adapted to identify and initialize the image-capturing device when the image-capturing device is connected to the imaging device.

26. An imaging device comprising:
an integrated circuit disposed between first and second ports, with the first port connectable to a host device and the second port connectable to an image-capturing device to enable data transmission from the image-capturing device to the host device through the circuit.

27. The imaging device of claim 26 further comprises a controller connected to the integrated circuit and a print engine connected to the controller.

28. The imaging device of claim 27 wherein the integrated circuit is integrated within the controller.

29. The imaging device of claim 26 wherein the integrated circuit includes a configuration to operate with a Universal Serial Bus.
